(19) United States
(12) Patent Application Publication
(10) Pub. No.: US 2004/0065656 A1
(43) Pub. Date: Apr. 8, 2004

(54) Heated substrate support

(76) Inventors: Makoto Inagawa, Palo Alto, CA (US); Akihiro Hosokawa, Cupertino, CA (US)

Correspondence Address: Patent Counsel, Applied Materials, Inc., P.O. Box 450A, Santa Clara, CA, 95052, US

(21) Appl. No.: 10/265,212

(22) Filed: Oct. 4, 2002

(51) Int. Cl. H05B 3/68

(52) U.S. Cl. 219/444.1; 219/390

(57) ABSTRACT

Embodiments of the invention generally provide a substrate support for supporting a substrate. In one embodiment, a substrate support is provided that includes a plate assembly having at least a first heating element disposed therein or coupled thereto. A plurality of thermal isolators are disposed through plate assembly, defining a plurality of temperature controllable zones across the plane of the plate assembly.

### BACKGROUND OF THE INVENTION

1. Field of the Invention

Embodiments of the invention relate to a method and apparatus for heating a large area glass substrate.

2. Background of Related Art

Thin film transistors (TFTs) are conventionally made on large glass substrates or plates for use in monitors, flat panel displays, solar cells, personal digital assistants (PDAs), cell phones and the like. TFTs are made in a cluster tool by sequential deposition of various films including amorphous silicon, doped and undoped silicon oxides, silicon nitride and the like in vacuum chambers typically disposed around a central transfer chamber. Production of good quality polysilicon precursor films utilized in these structures requires that the hydrogen content of the film be controlled below about 1 percent. In order to achieve this low hydrogen content, post deposition heat treatment of the film at temperatures of about 550 degrees Celsius is required.

As the substrates utilized in TFT manufacture are large, approaching 1.5 square meter in size, preheating the substrates prior to processing is desired to maximize substrate throughput. In order to efficiently preheat the substrates, a preheating chamber is generally coupled to the transfer chamber of the cluster tool that is capable of preheating a plurality of substrates within a vacuum environment. One such preheating chamber is available from AKT, a wholly owned division of Applied Materials, Inc., located in Santa Clara, Calif.

Generally, a substrate is set on one of a plurality of heated substrate supports disposed within the preheating chamber. The substrate support is typically fabricated by vacuum brazing a heating element between two stainless steel plates. The heating element heats the substrate support to a predetermined temperature. The heating element typically comprises a resistive heater disposed on a copper plate. The good heat transfer properties of the copper plate allow the heat from the heating element to be laterally distributed resulting in uniform temperatures across the surface of the shelf supporting the substrate.

Although this conventional configuration of a heated substrate support has shown to be robust and efficient, and produces good temperature uniformity on smaller substrates seated thereon, deflection of the substrate support configured for larger substrates is an unresolved issue. Larger heating capacity is typically added to the edges of the substrate support to compensate for the heat less through the wall of the chamber. As the size of the substrate support becomes larger, heat flux from the edge to the center of the substrate support is restricted by the small cross sectional area of the substrate support which is generally minimized to prevent weight increase and allow greater substrate stacking density. This results in a large temperature gradient between the edges and the center of the substrate support during transient heating stages (i.e., before the substrate reaches a steady-state temperature). As the unsupported edges of the substrate support may become hotter than the center and supported edges of the substrate support, the substrate support may warp, thus undesirably altering the designed spacing between the substrate and substrate support that creates non-uniform heating of the substrate.

Due to consumer demand and advances in process technology, the size of substrates utilized in the fabrication of TFTs on large area substrates is increasing rapidly. For example, substrates over 1 meter in length per side are currently being processed while processing of substrates exceeding 1.5 meter per side is envisioned. Accordingly, conventional substrate support may not be able to heat these larger substrates uniformly and at a rate acceptable to TFTs manufactures. Particularly, as substrates approach and exceed 1.2 to 1.5 meters in both length and width, uniform heating of substrates by substrate supports will become a paramount issue for enabling acceptable production throughput and processing quality on tooling configured to process these large area substrates.

Therefore, there is a need for an improved substrate support.

### SUMMARY OF THE INVENTION

Embodiments of the invention generally provide a substrate support for supporting a substrate. In one embodiment, a substrate support is provided that includes a plate assembly having at least a first heating element disposed therein or coupled thereto. A plurality of thermal isolators are disposed through plate assembly, defining a plurality of temperature controllable zones across the plane of the plate assembly.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is one embodiment of substrate support plate assembly for supporting a substrate illustratively disposed in a preheating chamber;

FIG. 2 is a top perspective view of the substrate support plate assembly of FIG. 1;

FIGS. 3A-E are perspective views of substrate support plate assemblies having alternative temperature control zone configurations;

FIG. 4 is partial sectional view of the substrate support plate assembly of FIG. 2;

FIG. 5 a bottom perspective view of another embodiment of a substrate support plate assembly;

FIG. 6 is a partial sectional view of another embodiment of a substrate support plate assembly;

FIG. 7 is a partial sectional view of another embodiment of a substrate support plate assembly;

FIG. 8 is a partial sectional view of another embodiment of a substrate support plate assembly;

FIG. 9 depicts an alternative attachment of a conduit to the substrate support plate assembly of FIG. 8; and

FIG. 10 is a top perspective view of another embodiment of a plate assembly.

To facilitate understanding, identical reference numerals have been used, wherever possible, to designate identical elements that are common to the figures.

### DETAILED DESCRIPTION OF THE PREFERRED EMBODIMENT

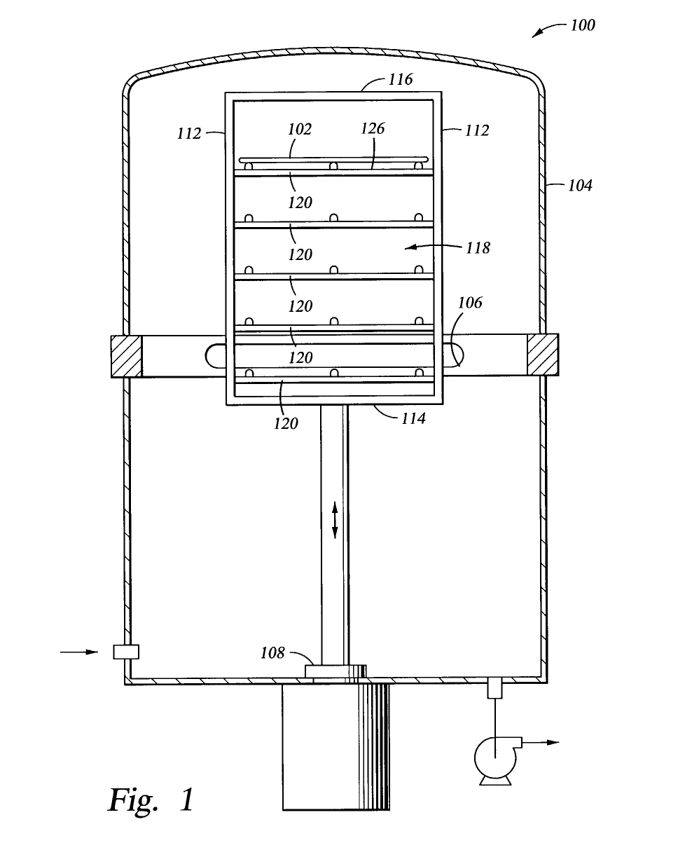

FIG. 1 depicts a heating chamber 100 having one embodiment of a heated substrate support plate assembly 120 disposed therein. Typically, the heating chamber 100 may be utilized in a cluster tool (not shown) adapted to process large area substrates. One cluster tool that may be benefit from the invention is a 15K PECVD platform, available from AKT, a wholly owned division of Applied Materials, Inc., located in Santa Clara, Calif. Although the plate assembly 120 is described as used in a heating chamber 100 adapted to preheat and/or anneal large substrates, the plate assembly 120 may also be used in other devices where heating of a substrate is desired.

The heating chamber 100 is generally comprises a chamber body 104 having a controlled environment in which a movable cassette 110 is disposed. The chamber body 104 includes at least one sealable substrate access port 106 for facilitating entry and egress of substrates from the chamber 100.

The cassette 110 generally includes walls 112, a bottom 114 and a top 116 that define an interior volume 118. A plurality of heated substrate support plate assemblies 120 are coupled to the walls 112 of the cassette 110. In the embodiment depicted in FIG. 1, five plate assemblies 120 are shown. However, it is to be understood that the cassette 110 may include any number of support plate assemblies 120.

The support plate assemblies 120 are typically arranged in a stacked, parallel orientation within the cassette 110 so that a plurality of large area substrates 102 may be heated or thermally regulated while being stored thereon. The bottom 114 of the cassette 110 is coupled to a lift mechanism 108 so that a selected plate assembly 120 may be aligned with the port 106 to facilitate substrate transfer.

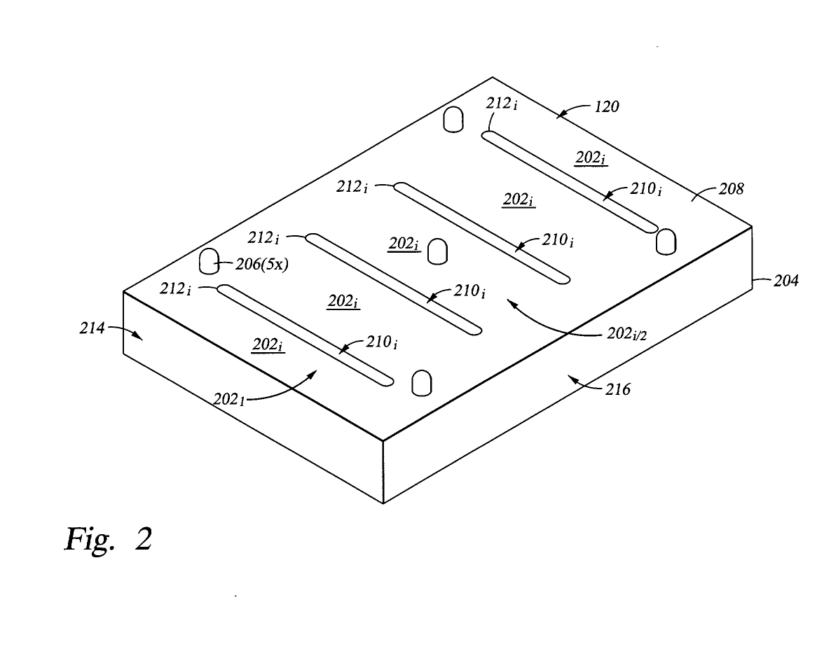

FIG. 2 depicts a top perspective view of one embodiment of a substrate support plate assembly 120. The plate assembly 120 generally includes a plurality of thermally decoupled (i.e., thermally isolated) temperature control zones 202ᵢ, where i is a positive integer. Each of the control zones 202, defined across one of the support plate assemblies 120 is adapted to regulate the heat transfer with a substrate supported thereover independently from the heat transfer to the substrate from the adjacent zones.

The plate assembly 120 generally includes at least a plate 204 having a plurality of spacers 206 extending from a top surface 208. The plate 204 is typically fabricated from stainless steel, nickel, copper, nickel plated copper or other suitable thermally conductive material. The plate 204 is typically rectangular in shape to support rectangular substrates 102. However, the plate 204 may be fabricated in other shapes.

The spacers 206 support the substrate 102 in a spaced-apart relation relative to the plate assembly 120. The spacers 206 may alternatively be coupled to the walls 112 of the cassette 110. The spacers 206 are generally comprised of a material and/or in a configuration that limits or eliminates scratching of the substrate 102 when it is moved across the spacer 206. One preheating chamber that may be adapted to benefit from the invention is described in U.S. patent Ser. No. 09/982,406, filed Oct. 17, 2001 by Hosokawa et al., which is hereby incorporated by reference in its entirety.

The temperature control zones 202ᵢ defined in the plate 204 are typically separated by thermal isolators 210ᵢ. In the embodiment depicted in FIG. 2, the thermal isolators 210ᵢ are slots 212ᵢ formed through the plate 204 that provide air gaps between adjacent zones 202ᵢ to limit conductive heat transfer through a plane laterally defined by the plate 204. For example, zone 202₁ may be heated more than zone_{i/2}. The air (or lack thereof in a vacuum environment) occupying each slot 212₁ substantially limits or prevents thermal conduction across the slot thereby allowing zone 202₁ to heat the portion of the substrate over that zone at a rate different than a portion of the substrate positioned over zone 202₂. This allows the substrate to be selectively heated across its width, thus compensating for temperature differences between the center and edges of the substrate, resulting in temperature uniformity across the width of the substrate.

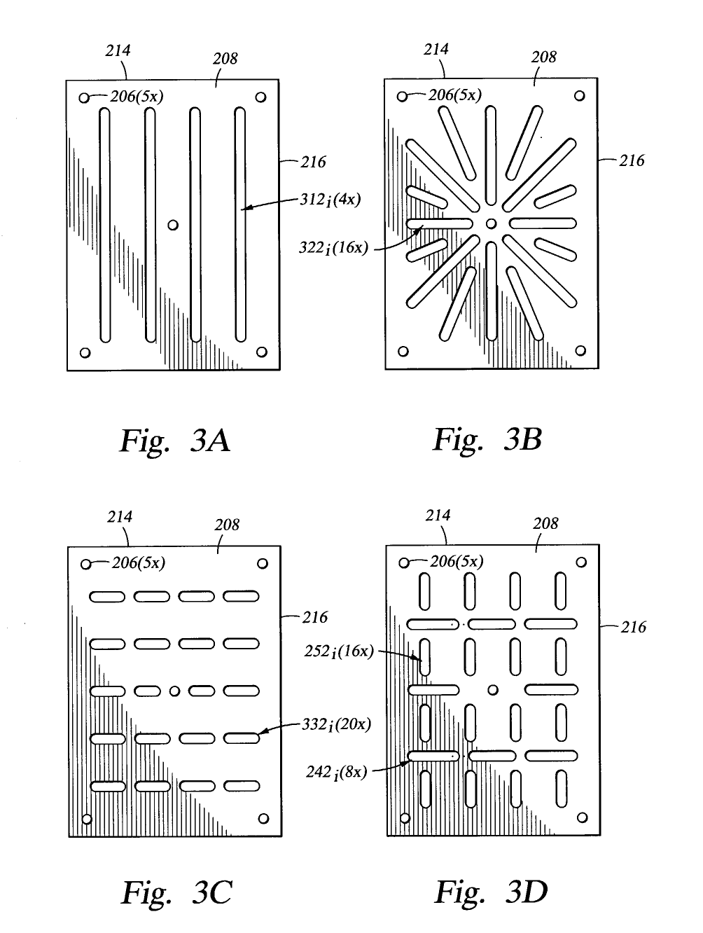

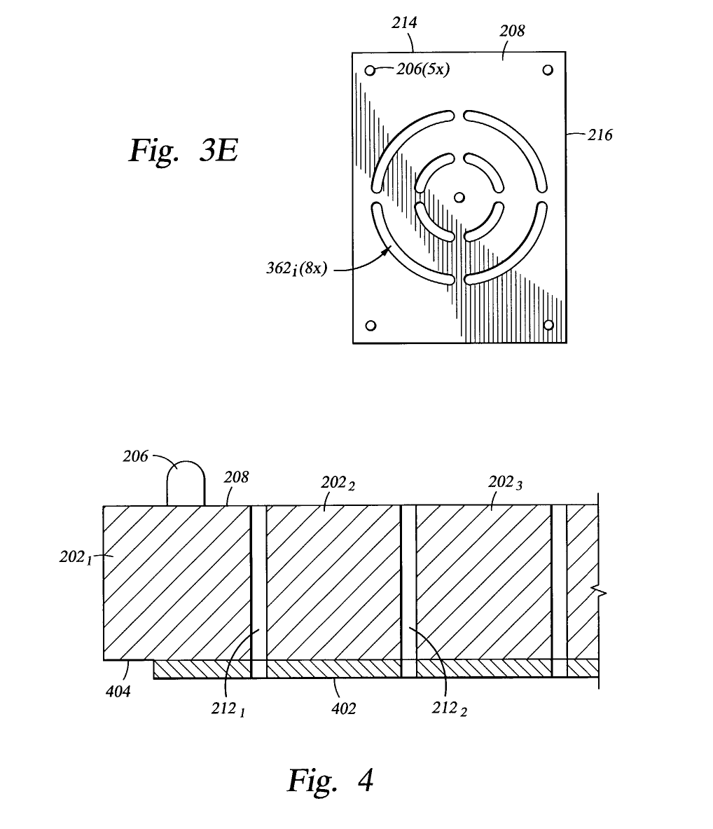

The slots 212ᵢ are configured to provide thermal isolation between predefined zones 202ᵢ so that the substrate may be heated in a predetermined way. For example, the slots 212ᵢ may be oriented parallel to first edge 214 of the plate 204 that is an unsupported by the walls 112 of the cassette 110. Typically, the first edge 214 is orientated along the long side of a rectangular substrate 102 (shown in phantom in FIG. 2). Alternatively, as illustrated in FIGS. 3A-E, the slots may be defined in another configuration, such as slots 312ᵢ parallel to a supported second edge 216 of the plate 204, radially disposed slots 32ᵢ, rows of linearly aligned slots segments 332ᵢ, lateral and longitudinal slots 342ᵢ, 352ᵢ configured as a grid, one or more concentric slots 362ᵢ, combinations thereof, or other orientation configured to provide a pre-defined pattern of thermal isolation across the substrate support plate assembly in order to provide independent temperature control of the substrate above each zone.

Referring back to FIG. 2, each zone 202ᵢ may have temperature control independent from temperature control of a neighboring zone 202ᵢ. For example a zone 202₁ may be configured to apply more heat to an edge of the substrate than a zone 202_{i/2} located near the center of the substrate to compensate for the tendency of the center of the substrate to be hotter than the edges.

The zones 202ᵢ are typically heated by one or more heating elements coupled to or disposed in the plate 204. The heating element may be a single continuous heater routed through the zones 202ᵢ configured to provide more heating capacity at predetermined locations (e.g., at least between zones and, optionally, within a single zone). Alternatively, one or more of zones 202ᵢ may have individual heating elements. The heating elements may be resistive heaters, thermoelectric devices, or conduits for flowing heat transfer fluid, among other heating devices. As the temperature and heat generation of each zone 202ᵢ is regulated independently, the temperature uniformity of a substrate supported by the plate 204 is advantageously enhanced, and the warpage of the substrate support that contributes to heating non-uniformity is substantially eliminated. Moreover, the uniform heating of the substrate by the plate assembly 120 promotes quality and repeatability of subsequent processes, while enhancing substrate throughput bring the substrate to a uniform temperature at faster rate compared to conventional support plate assemblies.

FIG. 4 is a partial sectional view of zones 202₁₋₃ of the plate assembly 120. A resistive heater 402 is coupled to a bottom surface 404 of the plate 204 opposite the top surface 208 by a thermally conductive adhesive. Alternatively, the resistive heater 402 may be coupled to the plate 204 by other methods, for example, bonding, fastening or clamping. The resistive heater 402 is routed through each of the zones 202₁₋₄. As the slots 212₁₋₃ separating the zones 202₁₋₄ allows each zone to be thermally regulated substantially independent from the adjacent zones, the routing of the resistive heater 402 is less complicated than conventional plate assemblies that do not have thermally isolated heating zones, thereby advantageously reducing the cost of the plate assembly 120.

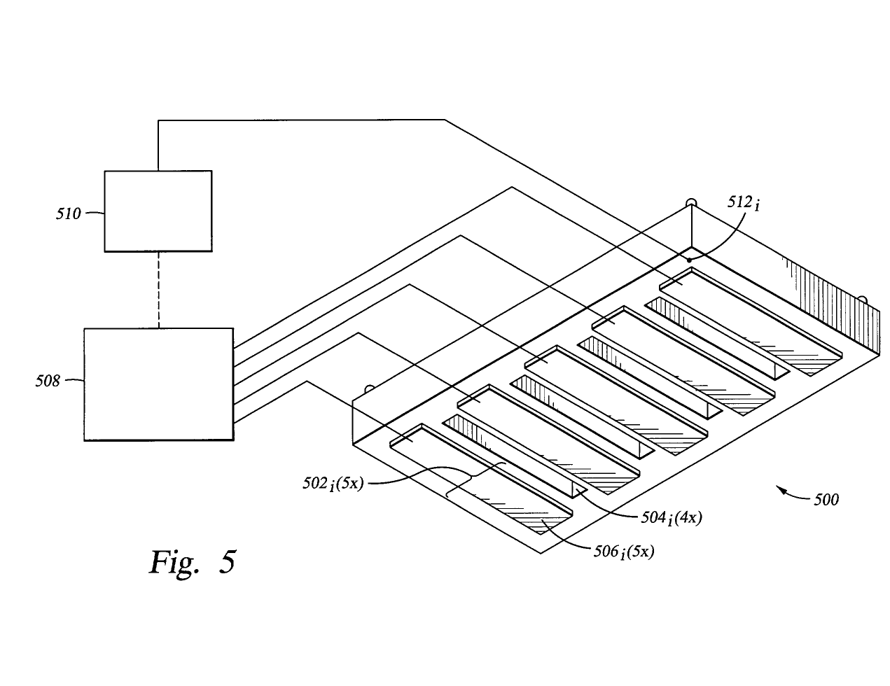

FIG. 5 is a bottom perspective view of another embodiment of a plate assembly 500. The plate assembly 500 includes a plurality of thermally regulated zones 502ᵢ separated by a plurality of thermal isolators 504ᵢ. The thermal isolators 504ᵢ may be air gaps, thermally insulative material, or other feature that deters or prevents conductive heat transfer between the zones 502_{i.}

A resistive heater 506ᵢ is respectively coupled to each zones 502ᵢ. Each resistive heater 506ᵢ is coupled to a multiple-output power source 508 and controller 510 that facilitates thermal regulation of each zone 502ᵢ by controlling the power applied to each resistive heater 506ᵢ. The uniform heating of the substrate supported by the plate assembly 500 may be enhanced by providing temperature information collected at each zone 502ᵢ by a thermocouple 512ᵢ or other temperature sensing device to the controller 510 so that the substrate may be maintained a predefined, uniform temperature, typically at about 300 to about 520 degrees Celsius. Only one of the thermocouples 51ᵢ is shown in FIG. 5 to prevent crowding the drawing.

FIG. 6 is a partial sectional view of another embodiment of a plate assembly 600. The plate assembly 600 includes a plurality of thermally regulated zones 602ᵢ separated by thermal isolators 606ᵢ. The thermally regulated zones 602ᵢ generally have one or more heating elements 604ᵢ coupled thereto. The thermal isolator 606ᵢ is one or more slots or grooves that are configured to create a heat choke between adjacent zones 602i. In the embodiment depicted in FIG. 6, at least one of the thermal isolators 606ᵢ is defined by a first groove 608 formed in a top surface 610 of the plate assembly 600 and a second groove 612 in a bottom surface 614 of the plate assembly 600. A narrow strip 616 defined between the grooves 608, 612 and connecting the adjacent zones 602ᵢ, has a significantly reduced sectional area relative to the plate assembly 600, thus limiting heat transfer between zones thereby facilitating thermal control of substrate heating by zone.

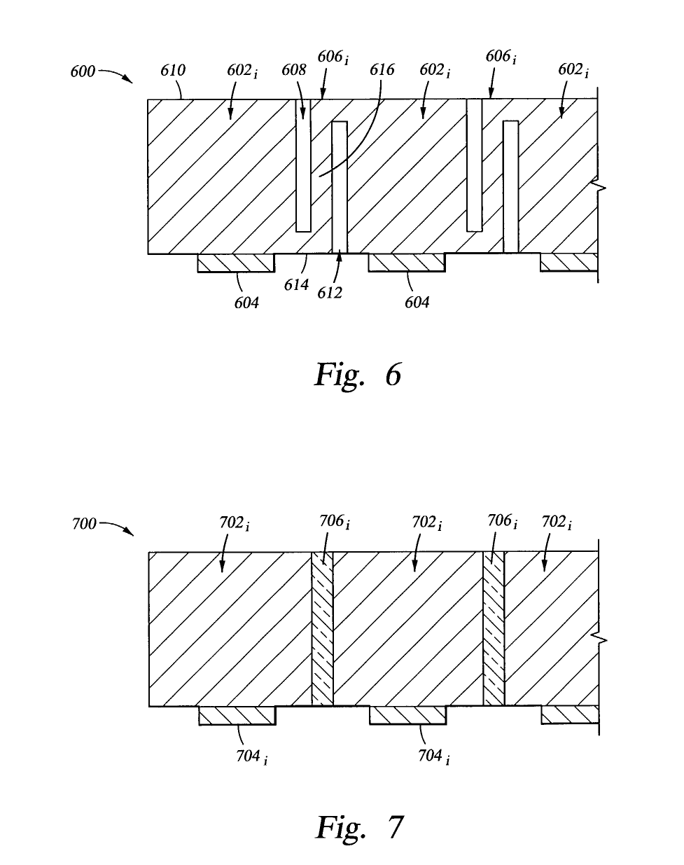

FIG. 7 is a partial sectional view of another embodiment of a plate assembly 700. The plate assembly 700 includes a plurality of thermally regulated zones 702ᵢ having one or more heating elements 704ᵢ coupled thereto and separated by thermally insulative material 706ᵢ. The insulative material 706ᵢ is selected to deter or prevent conductive heat transfer between the zones 702ᵢ and may be fabricated from a variety of materials including ceramic, high temperature plastic, reinforced resins, among other materials.

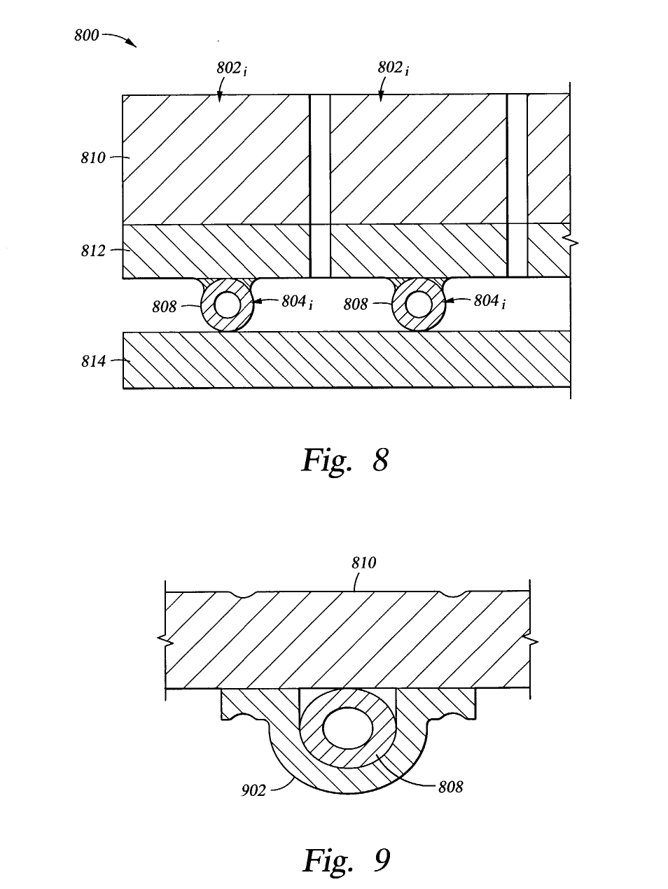

FIG. 8 is a partial sectional view of another embodiment of a plate assembly 800. The plate assembly 800 includes a plurality of thermally regulated zones 802ᵢ having one or more heating elements 804ᵢ coupled thereto and separated by thermally isolators 806ᵢ. The thermally isolators 806ᵢ may be slits formed in or through the plate assembly 800, which may optionally be filled with thermally insulative material.

In the embodiment depicted in FIG. 8, the heating elements 804ᵢ comprise a conduit 808 coupled to a top plate 810 that is adapted is support a substrate during thermal processing. The top plate 810 is typically fabricated from stainless steel or other metal. A copper plate 812 may optionally be disposed between the conduit 808 and the top plate 810 to enhance heat transfer from the conduit 808 laterally across the width of each zone 802ᵢ. A bottom plate 814, typically fabricated from stainless steel or other rigid material, may be utilized to sandwich the conduit 808 with the top plate 810.

Alternatively, as depicted in FIG. 9, the conduit 808 may be urged against the top plate 810 by a bracket 902 that is spot welded or otherwise fastened to the top plate 810. One substrate support that may be adapted to benefit from the invention is described in U.S. patent application Ser. No. 09/921,104, filed Aug. 1, 2001, which is hereby incorporated by reference in its entirety.

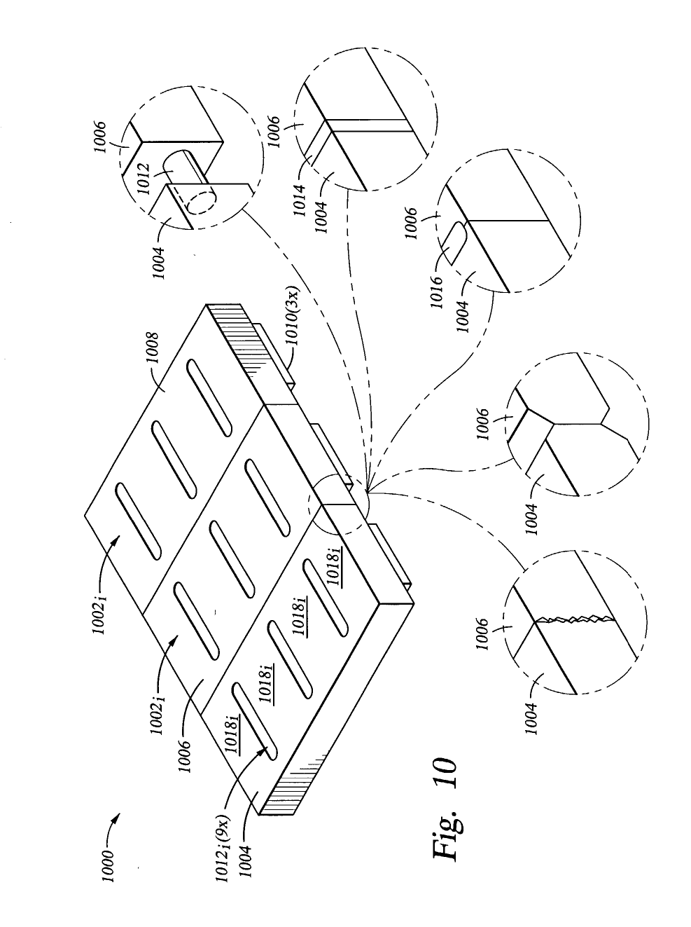

FIG. 10 is a top perspective view of another embodiment of a plate assembly 1000 having a plurality of thermally decoupled (i.e., thermally isolated) temperature control zones 1002ᵢ. Each of the control zones 1002ᵢ is adapted to regulate the heat transfer between the substrate supported on the plate assembly 1000 and the adjacent zones.

The plate assembly 1000 is fabricated from a plurality of plates, shown for simplicity as a first edge plate 1004, a center plate 1006 and a second edge plate 1008. Any number of plates, coupled together in any planar configuration (i.e., lateral, radial, grid and the like), may be utilized. Each plate 1004, 1006 and 1008 defines at least one of the temperature control zones 1002ᵢ. The resistance to conductive heat transfer across the adjoining surfaces of the plates 1004, 1006, 1008 functions as a thermal isolator, allowing each plate 1004, 1006, 1008 to be thermally regulated by at least one heating element 1010 coupled thereto independently from the neighboring plate(s).

The use of multiple plates to fabricate the plate assembly 1000 provides modularity that both reduces costs and facilitates maintenance and repair. Moreover, as the size of the plate assemblies exceeds 1500 mm per edge, the size of each heating element 1010 coupled to each plate remains within the capability of presently known manufacturing techniques and production tooling, thereby preventing heater technology from becoming a limiting factor in the realization of larger plate assemblies.

The thermal isolation between plates 1004, 1006, 1008 may be enhanced by a number of methods. In one example, the contact area between the plates may be reduced. This may be accomplished by having rough surface finishes between the plates, necking or reducing the sectional area of the edge of the plates, or spacing the plates utilizing bosses 1012 or other features. In another example, the thermal isolation between the plates may be enhanced by inserting a thermally insulative material 1014 between the plates as described above. In yet another example, the thermal isolation between the plates may be enhanced spacing the plates to create an air gap 1016 therebetween.

Optionally, one or more of the plates 1004, 1006, 1008 may be divided into sub-zones 1018ᵢ. The sub-zones 1018ᵢ may be separated by thermal isolator such as slots 1020 depicted in FIG. 10, or alternatively be separated by thermally isolative material or other feature to limit conductive heat transfer as described above. The sub-zones 1018ᵢ provide for a level of temperature control within one of the plates independent of the temperature control between plates, thereby facilitating temperature control in at least two directions across the plane of the substrate.

Thus, a substrate support plate assembly having a plurality of temperature control zones has been provides. The temperature control zones enhance temperature uniformity of substrates heated by the support plate, while facilitating economical fabrication by minimizing heater complexity. Moreover, as substrate temperature uniformity is enhanced, processing quality and throughput are desirably enhanced.

While the foregoing is directed to the preferred embodiment of the present invention, other and further embodiments of the invention may be devised without departing from the basic scope thereof, and the scope thereof is determined by the claims that follow.

What is claimed is:

1. A substrate support for supporting a substrate, comprising:
a plate assembly having a first surface adapted to support the substrate and an opposing second surface;
a plurality of thermal isolators disposed in the plate assembly and defining a plurality of temperature controllable zones; and
at least a first heating element disposed in or coupled to the second surface of the plate assembly.

2. The substrate support of claim 1, wherein at least one of the plurality of thermal isolators further comprises:
a slot formed through the plate assembly.

3. The substrate support of claim 1, wherein the plurality of thermal isolators further comprises:
a plurality of slots formed through the plate assembly.

4. The substrate support of claim 3, wherein the plurality of slots are arranged in rows.

5. The substrate support of claim 4, wherein at least one of the rows is comprised of linearly aligned slots.

6. The substrate support of claim 3, wherein the plurality of slots are arranged in a grid pattern.

7. The substrate support of claim 3, wherein the plurality of slots are arranged in concentrically.

8. The substrate support of claim 1, wherein at least one of the plurality of thermal isolators further comprises:
a thermally insulative material disposed in the plate assembly.

9. The substrate support of claim 1, wherein at least one of the plurality of thermal isolators further comprises:
a groove extending partially through the plate assembly.

10. The substrate support of claim 1, wherein at least one of the plurality of thermal isolators further comprises:
a first groove extending partially through the first surface the plate assembly;
a second groove extending partially through the second surface the plate assembly; and
a strip defined between the first and second grooves adapted to limit conductive heat transfer between a first temperature controllable zone adjacent the first groove and a second temperature controllable zone adjacent the second groove.

11. The substrate support of claim 1, wherein the first heating element is selected from a group consisting of a resistive heater, a heat transfer fluid conduit and a thermal electric device.

12. The substrate support of claim 1, wherein the first heating element is a resistive heater coupled to the second surface of the plate assembly.

13. The substrate support of claim 1, wherein the first heating element is configured to heat at least two of the temperature controllable zones at different rates.

14. The substrate support of claim 1 further comprising:
a second heating element coupled to or disposed in the second surface of the plate assembly, the second heating element and the first heating element adapted to heat at least two of the temperature controllable zones differently.

15. The substrate support of claim 14, wherein the first and second heating elements are independently controlled.

16. The substrate support of claim 15 further comprising at least one temperature sensing device adapted to provide a metric indicative of the temperature of at least two of the temperature controllable zones.

17. The substrate support of claim 1, wherein the plate assembly further comprises:
a plurality of plates arranged in a common plate, each plate defining at least one of the temperature controllable zones.

18. The substrate support of claim 17, wherein at least one of the plates is divided into temperature controlled sub-zones.

19. The substrate support of claim 18, wherein at least two of the sub-zones are separated by an air gap, a groove framed partially through the plate, a reduced are contact region or a slot formed through the plate.

20. A substrate support for supporting a substrate, comprising:
a plate assembly having a first surface and an opposing second surface;
a plurality of spacers disposed on the plate assembly and adapted to maintain the substrate and first surface in a spaced-apart relation;
a plurality of slots defined in the plate; and
a first heating element disposed in or coupled to the plate assembly.

21. The substrate support of claim 20, wherein the plurality of slots are arranged in rows.

22. The substrate support of claim 21, wherein at least one of the rows is comprised of linearly aligned slots.

23. The substrate support of claim 20, wherein the plurality of slots are arranged in a grid pattern.

24. The substrate support of claim 20, wherein the plurality of slots are arranged in concentrically.

25. The substrate support of claim 20 further comprising:
a thermally insulative material disposed in at least one of the slots.

26. The substrate support of claim 20, wherein at least one of the slots extends partially through the plate assembly.

27. The substrate support of claim 20, wherein the first heating element is configured to heat at least two of the temperature controllable zones at different rates.

28. The substrate support of claim 20 further comprising a second heating element controlled independently from the first heating element.

29. The substrate support of claim 20, wherein the plate assembly further comprises:
a plurality of plates arranged in a common plate, each plate defining at least one of the temperature controllable zones.

30. The substrate support of claim 29, wherein at least one of the plates is divided into temperature controlled sub-zones.

31. The substrate support of claim 29, wherein at least two of the sub-zones are separated by an air gap, a groove framed partially through the plate, a reduced area contact region or a slot formed through the plate.

32. A heating chamber for heating a substrate, the chamber comprising:
a chamber body defining an interior volume,
a substrate storage cassette having walls;
a plurality of support plate assemblies coupled to the walls and stacked parallel to each other within the interior volume, the support plate assemblies each having a first surface adapted to support the substrate;
at least one thermal isolator disposed through at least one of the plate assemblies and defining a plurality of temperature controllable zones; and
at least a first heating element coupled to or disposed in each support plate assembly.

33 The heating chamber of claim 32, wherein at least one of the plurality of thermal isolators further comprises:
a slot formed at least partially through the plate assembly.

34. The heating chamber of claim 32, wherein the plurality of thermal isolators further comprises:
a plurality of slots formed through the plate assembly.

35. The substrate support of claim 34, wherein the plurality of slots are arranged in rows, a grid pattern, concentrically or combinations thereof.

36. The substrate support of claim 34, wherein the plurality of slots includes at least one row of linearly aligned slots.

37. The heating chamber of claim 32, wherein at least one of the plurality of thermal isolators further comprises:
a thermally insulative material disposed in the plate assembly.

38. The heating chamber of claim 32, wherein the first heating element is selected from a group consisting of a resistive heater, a heat transfer fluid conduit and a thermal electric device.

39. The heating chamber of claim 32, wherein the first heating element is configured to heat at least two of the temperature controllable zones at different rates.

40. The heating chamber of claim 32 further comprising a second heating element disposed in or coupled to the plate assembly and adapted to heat the plate assembly at a rate different than the first heating element.

41. The heating chamber of claim 32 further comprising a second heating element controlled independently from the first heating element.

42. The heating chamber of claim 32 further comprising at least one temperature sensing device adapted to provide a metric indicative of the temperature of at least two of the temperature controllable zones.

43. The heating chamber of claim 32, wherein the plate assembly further comprises:
a plurality of plates arranged in a common plate, each plate defining at least one of the temperature controllable zones.

44. The heating chamber of claim 43, wherein at least one of the plates is divided into temperature controlled sub-zones.

45. The heating chamber of claim 44, wherein at least two of the sub-zones are separated by an air gap, a groove framed partially through the plate, a reduced are contact region or a slot formed through the plate.

46. A method for controlling temperature of a substrate disposed on a substrate support plate assembly, comprising:
heating a first zone of the substrate support plate assembly; and
heating a second zone of the substrate support plate assembly that is thermally isolated from the first zone.

47. The method of claim 46, wherein the heating of the first zone is controlled independently from and the heating of the second zone.
